(19) United States
(12) Patent Application Publication
(10) Pub. No.: US 2012/0262256 A1
(43) Pub. Date: Oct. 18, 2012

(54) OPERATION INPUT DEVICE

(75) Inventors: Kenichi FURUKAWA, Tokyo (JP); Takayuki Numakunai, Tokyo (JP); Kensuke Yamada, Tokyo (JP)

(73) Assignee: MITSUMI ELECTRIC CO., LTD., Tokyo (JP)

(21) Appl. No.: 13/443,022

(22) Filed: Apr. 10, 2012

(30) Foreign Application Priority Data
Apr. 12, 2011 (JP) 2011-088351

(51) Int. Cl. H01H 13/50; H01H 36/00

(52) U.S. Cl. 335/106

(57) ABSTRACT

An operation input device includes an operation member that includes an operation surface having an outer edge part and is configured to be displaced downward by an input operation force exerted on the operation surface, a yoke attached to the operation member, a coil that detects a position of the operation member based on a position of the yoke and outputs a signal corresponding to an amount in which the operation member is displaced downward, and an engagement part that is positioned below the operation member and configured to contact the operation member at a contact position immediately below the outer edge part of the operation member. The engagement part is configured to constrain the operation member so that the operation member is not displaced further downward than the contact position when the engagement part contacts the operation member.

### BACKGROUND OF THE INVENTION

1. Field of the Invention

The present invention generally relates to an operation input device that includes an operation member having an operation surface and outputs a signal corresponding to the displacement of the operation member.

2. Description of the Related Art

FIG. 1 is a cross-sectional view of an operation input device 6 illustrated in Japanese Laid-Open Patent Publication No. 2011-3536. FIG. 1 illustrates a state where no input operation force is exerted on the operation input device 6. The operation input device 6 includes an upper yoke 260 and cores 261, 263 provided above coils 271 and 273. Further, the operation input device 6 includes a lower yoke 280 provided below the coils 271 and 273.

By engaging a key 240 with an opening part 231 of a case 230, the key 240 becomes immovable relative to the X direction (not illustrated) and the Y direction, but movable relative to the Z direction. The key 240 may also be referred to as a control member. In a state where an initial load is applied from a coil-like return spring 250 to the key 240 in the Z direction, the key 240 is in contact with an upper inner surface 232 of the case 230. One end of the return spring 250 contacts a lower center part of the key 240 and the other end of the return spring 250 contacts an upper center part of the lower yoke 280. The return spring 250 penetrates through a hole provided at a center part of the upper yoke 260 contacting a lower surface of the key 240. The upper yoke 260, which is formed from a magnetic material (e.g., a steel plate, ferrite), moves substantially in the same direction as that of the key 240 in correspondence with the movement of the key 240.

FIG. 2 is another cross-sectional view of the operation input device 6. FIG. 2 illustrates a state where an input operation force is exerted on the operation input device 6 in a direction causing the key 240 to incline toward the coil 271 relative to the X-Y plane. When such an input operation force is exerted, the upper yoke 260 and the core 261 are moved closer toward the coil 271 where the upper inner surface 232 of the cover 230 acts as a fulcrum of the inclination (left side in FIG. 2). As the upper yoke 260 and the core 261 move closer toward the coil 271, the magnetic permeability surrounding the coil 271 increases. As the magnetic permeability increases, the self-inductance of the coil 271 increases. The same occurs when the key 240 is inclined in other directions. Therefore, by evaluating the inductance of each of the coils 271, 273, the direction of the inclination of the key 240 and the amount of inclination (amount of displacement) of the key 240 can be detected.

In the case where the key 240 is inclined in which the upper inner surface 232 of the cover 230 acts as the fulcrum of the inclination, the inclining of the key 240 stops when a protrusion formed at the lower center part of the key 240 abuts an engagement part 281.

However, in the state illustrated in FIG. 2 where the protrusion formed at the lower center part of the key 240 abuts the engagement part 281, the upper yoke 260 may deform when the input operation force exerted on the key 240 surpasses a plastic range (plastic deformation range) of the upper yoke 260. The deformation of the upper yoke 260 causes the evaluation value of the inductance of each of the coils 271, 272 to vary. The varying evaluation value of the inductance of each of the coils 271, 272 causes the error of the detected amount of displacement of the key 240 to become large.

### SUMMARY OF THE INVENTION

The present invention may provide an operation input apparatus that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by an operation input apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an operation input device including an operation member that includes an operation surface having an outer edge part and is configured to be displaced downward by an input operation force exerted on the operation surface, a yoke attached to the operation member, a coil that detects a position of the operation member based on a position of the yoke and outputs a signal corresponding to an amount in which the operation member is displaced downward, and an engagement part that is positioned below the operation member and configured to contact the operation member at a contact position immediately below the outer edge part of the operation member, wherein the engagement part is configured to constrain the operation member so that the operation member is not displaced further downward than the contact position when the engagement part contacts the operation member.

Other objects and further features of the present invention will be apparent from the following detailed description when read in conjunction with the accompanying drawings.

### BRIEF DESCRIPTION OF THE DRAWINGS

FIG. 1 is a cross-sectional view illustrating a state where no input operation force is exerted on an operation input device according to a related art example;

FIG. 2 is a cross-sectional view illustrating a state where an input operation force is exerted on an operation input device in a direction causing a key to incline toward a coil relative to an X-Y plane according to a related art example;

FIG. 3 is an exploded perspective view of an operation input device according to an embodiment of the present invention;

FIG. 4 is a plan view of an operation input device according to an embodiment of the present invention;

FIG. 5A is a cross-sectional view of an operation input device taken along line A-A of FIG. 4;

FIG. 5B is a cross-sectional view taken along line B-B of FIG. 4;

FIG. 5C is a cross-sectional view of a operation input device in a state where a direction key is displaced by receiving an input operation force and inclined toward one side, according to an embodiment of the present invention;

FIG. 6A is a front view illustrating a part of an inner side of a case according to an embodiment of the present invention; and

FIG. 6B is a perspective view illustrating a part of an inner side of a case according to an embodiment of the present invention.

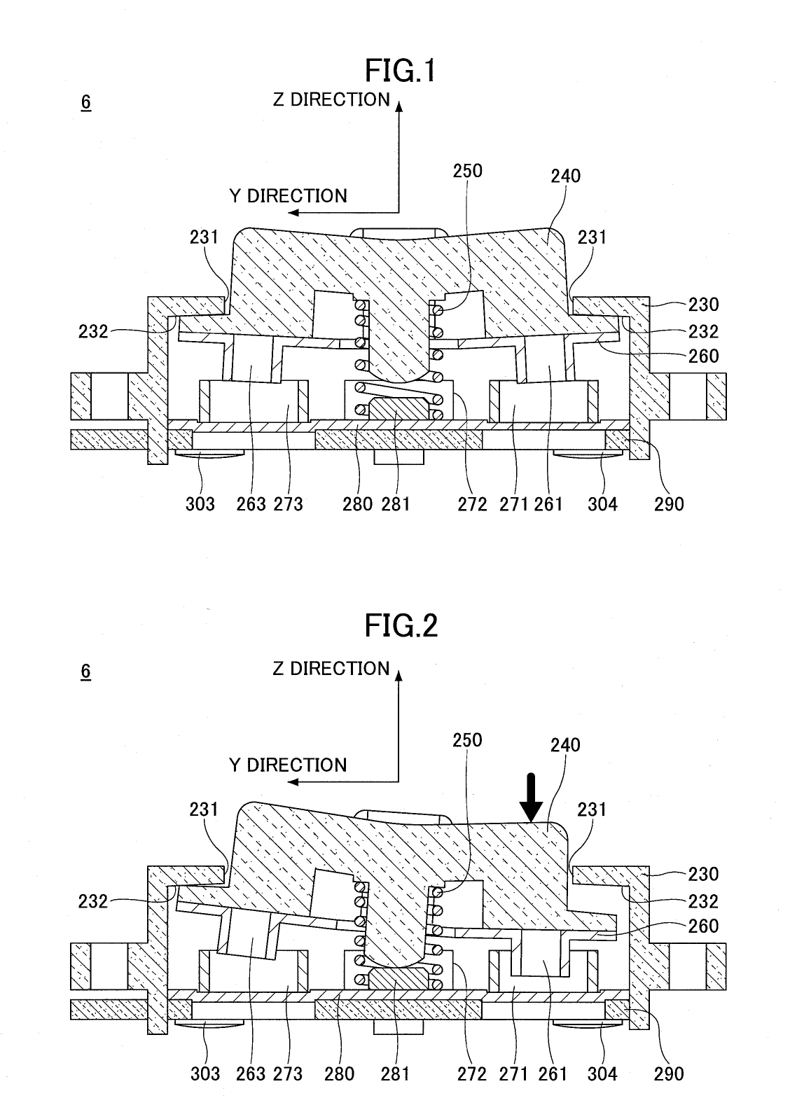

### DESCRIPTION OF THE PREFERRED EMBODIMENTS

In the following, embodiments of the present invention will be described with reference to the accompanying drawings.

An operation input device 1 according to an embodiment of the present invention is an operation interface which receives a force exerted from, for example, a finger of a hand of an operator (input operation force) and outputs a signal that changes in correspondence with the received input operation force. Based on the output signal, the input operation force of the operator is detected. By the detection of the input operation force, a computer can determine an operation content corresponding to the detected input operation force.

For example, in a case where the operation input device 1 is used in an electronic device such as a remote control device (e.g., remote controller of a game machine or a television set), a portable terminal (e.g., mobile phone, portable music player), a personal computer, or an electric appliance, a display object (e.g., an indicator such as a cursor or a pointer, a popular character) displayed on a screen of a display of the electronic device can be moved in correspondence with the operation content intended by the operator via the operation input device 1. Further, by receiving a specific input operation force exerted by the operator, the operation input device 1 can cause the electronic device to execute a desired function in correspondence with the input operation force.

For example, in a case where the inductance of an inductor of the below-described winding wire (coil) of the operation input device 1 is represented as “L”, the coefficient of the inductance of the winding wire is represented as “K”, the magnetic permeability of the winding wire is represented as “μ”, the number of coils of the winding wire is represented as “n”, the area of the cross section of the winding wire is represented as “S”, and a magnetic path length of the winding wire is represented as “d”, the following formula is satisfied.

L=Kμn²S/d

As shown with this formula, it can be understood that the inductance changes when at least one of the magnetic permeability and the magnetic path length surrounding the winding wire is changed, where parameters that vary according to the shape of the winding wire (e.g., the number of coils of the winding wire, the area of the cross section of the winding wire) are fixed.

Next, embodiments of the operation input device 1 utilizing the changing inductance are described.

In an orthogonal coordinate system defined by X, Y, Z axes, the control input device 1 is configured to receive a force exerted onward a positive Z coordinate direction by an operator (input operation force).

As described below, the control input device 1 includes a displacement member that changes the inductance of a coil(s) by being displaced by the input operation force in such a manner that a positional relationship between the coil and the displacement member is changed. The control input device 1 refers to a predetermined signal that changes in correspondence with the size of the inductance of the coil. Based on the predetermined signal, the control input device 1 can detect the movement of the displacement member moving in correspondence with the input operation force of the operator.

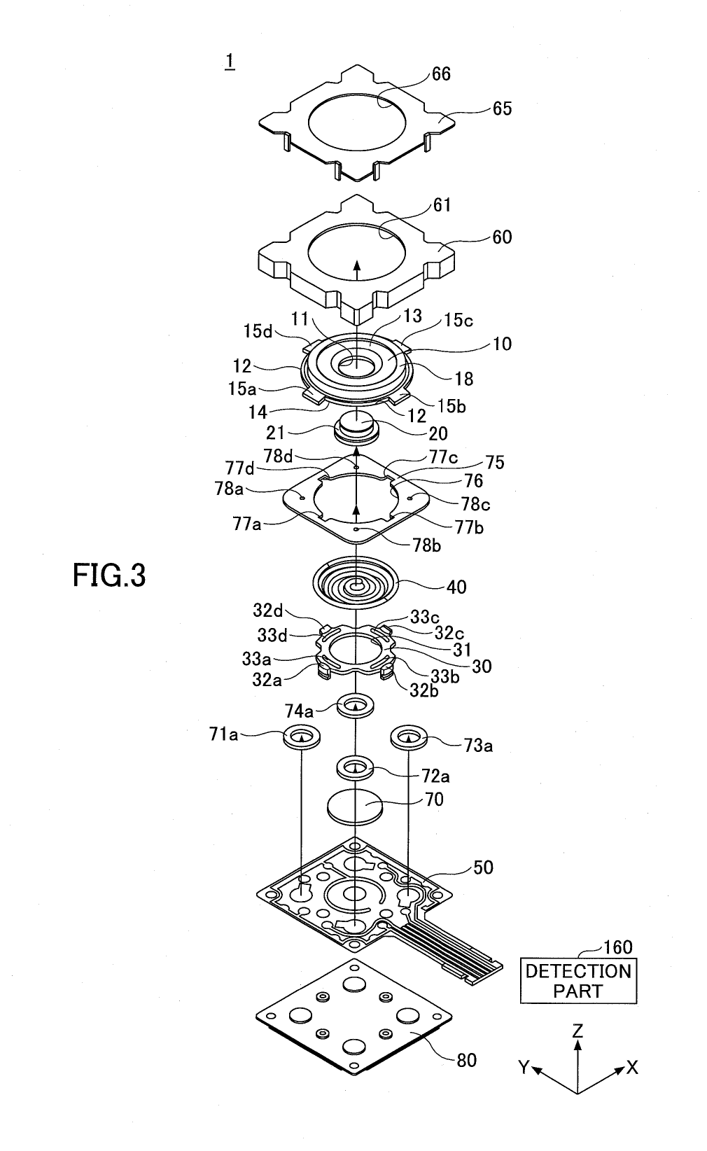

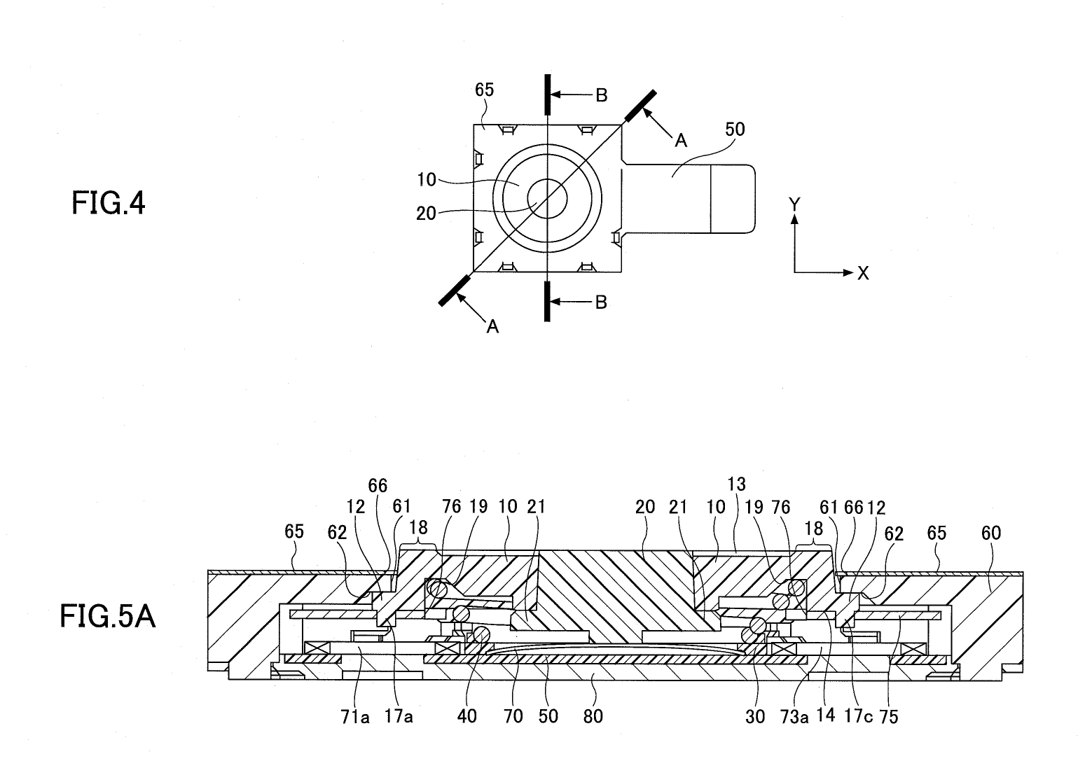

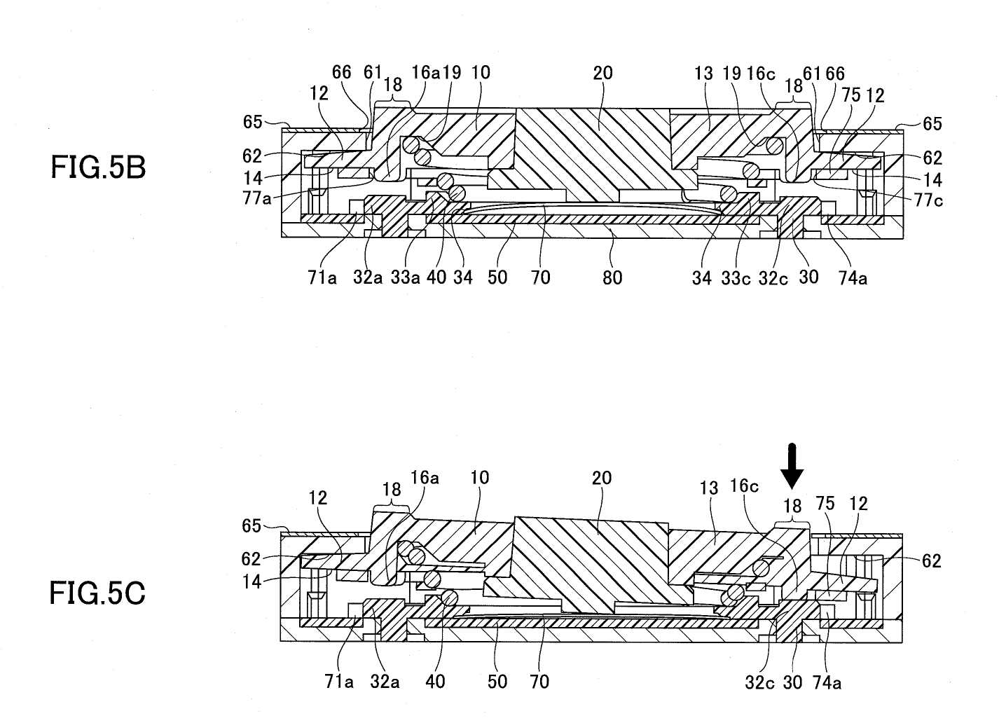

FIG. 3 is an exploded perspective view of the operation input device 1 according to an embodiment of the present invention. FIG. 4 is a plan view of the operation input device 1 according to an embodiment of the present invention. FIG. 5A is a cross-sectional view of the operation input device 1 taken along line A-A of FIG. 4. FIG. 5B is a cross-sectional view taken along line B-B of FIG. 4. FIG. 5C is a cross-sectional view of the control input device 1 in a state where a direction key 10 is displaced by receiving an input operation force and inclined toward one side. The direction key 10, which is included in the operation input device 1, is displaced by receiving the input operation force. The operation input device 1 outputs a signal corresponding to the amount in which the direction key 10 is displaced (displacement amount).

The control input device 1 includes the direction key 10, an upper yoke 75, coils 71a, 72a, 73a, 74a, and a lower hard stop part 30. The direction key 10 includes an operation surface 13. The direction key 10, which is also referred to as an operation member, can be displaced by an input operation force exerted on the operation surface 13. For example, the direction key 10 may be displaced in a manner inclined downward when an input operation force is exerted on the operation surface 13.

The upper yoke 75 is attached to a lower surface 14 of the operation key 10. Accordingly, the upper yoke 75 is displaced cooperatively with the displacement of the operation key 10. In this embodiment, bosses 17a-17d (see FIGS. 5A) are formed on the lower surface 14 of the operation key 10 in a manner protruding from the lower surface 14. The bosses 17a-17d are inserted into corresponding attachment holes 78a-78d formed in four corners of the upper yoke 75. Thereby, the position of the upper yoke 75 is set on the lower surface 14 of the direction key 10. The coils 71a, 72a, 73a, 74a detect the position of the direction key 10 without contacting the direction key 10. The coils 71a, 72a, 73a, 74a detect the position of the direction key 10 based on the position of the upper yoke 75 and output a signal(s) in correspondence with the amount in which the direction key 10 is displaced downward. The lower hard stop part 30, which is also referred to as an engagement part, is positioned below the direction key 10. The lower hard stop part 30 includes a contact surface 32 (32a-32d). The contact surface 32 of the lower hard stop part 30 has a contact area that contacts the direction key 10 immediately below an outer edge part 18 of the operation surface 13. The lower hard stop part 30 constrains the direction key 10 so that the direction key 10 is not displaced further downward than the contact area of the contact surface 32 when the lower hard stop part 30 contacts the direction key 10. In other words, the direction key 10 can be displaced downward until contacting the contact surface 32.

Owing to the configuration of the operation input device 1, a large load of the input operation force is exerted on the direction key 10 and the lower hard stop part 30 but not on the upper yoke 75 in a state where the direction key 10 is contacting the contact surface 32 immediately below the outer edge part 18 (hard stop state). Thereby, deformation of the upper yoke 75 can be prevented. Accordingly, error in detecting the amount of displacement of the direction key 10 can be reduced. Further, because the area in which the direction key 10 contacts the lower hard stop part 30 is located immediately below the outer edge part 18 of the direction key 10, components such as the direction key 10 are subjected to compression stress rather than bending stress. Therefore, the strength of the hard stop configuration of the operation input device 1 can be increased.

Further, in this embodiment, protrusion parts are formed on the lower surface 14 of the direction key 10 in a manner protruding further downward than the lower surface of the upper yoke 75. In this embodiment, the protrusion parts may be referred to as upper hard stop parts 16a-16d (see, for example, FIGS. 5B and 5C). The upper hard stop parts 16a-16d are formed in parts of the lower surface 14 of the direction key 10 located immediately below the outer edge part 18. The upper hard stop parts 16a-16d penetrate through an opening 76 formed in a center part of the upper yoke 75. More specifically, in this embodiment, the upper hard stop parts 16a-16d penetrate through lightening holes (recesses) 77a-77d formed in the peripheral part of the opening 76 in a manner facing corresponding upper hard stop parts 16a-16d (see FIG. 5B) and contact the contact surface 32 of the lower hard stop part 30 facing the upper hard stop parts 16a-16d. The contact surface 32 is formed on the upper surface of the lower hard stop part 30 so that the direction of the normal line of the contact surface 32 becomes a vertical direction. It is preferred that the upper hard stop parts 16a-16d establish surface-to-surface contact with respect to the contact surface 32 in order to disperse the shock when making contact.

Further, the operation input device 1 includes a return spring (elastic member) 40 that exerts an upward force on the direction key 10. The return spring 40 causes a flange 12 of the direction key 10 to contact an upper member positioned above the flange 12 such as a portion of a case 60. The case 60 may be, for example, a housing of an electronic device (e.g., game device) on which the operation input device 1 is mounted. This elastic member (return spring) 40 provides the direction key 10 with a returning force, so that the direction key 10 returns to an initial position (a state where no input operation force is applied to the direction key 10). The return spring 40 penetrates the same openings through which the upper hard stop parts 16a-16d penetrate. An upper end of the return spring 40 engages an annular recess part 19 formed at the lower surface 14 of the direction key 10. Thereby, the position of the upper end of the return spring 40 is set.

The lower hard stop part 30 includes return spring holders (return spring support parts) 33a-33d that support the return spring 40. Thereby, the hard stop function and a function of setting the lower end of the return spring 40 can be achieved by using the same component (i.e. lower hard stop part 30). A click spring holder (opening) 34 is formed at a center part of the lower hard stop part 30. A step part is formed at a peripheral part of the click spring holder 34. The step part and the below-described substrate (base part) 50 provided below the click spring holder 34 hold a peripheral part of the below-described click spring 70 therebetween, so that the click spring 70 is fixed. Owing to the step part, a fixing film (e.g., laminate film) covering an upper surface of the click spring 70 is not required for holding the click spring 70. Thereby, the number of components can be reduced and assembly can be simplified.

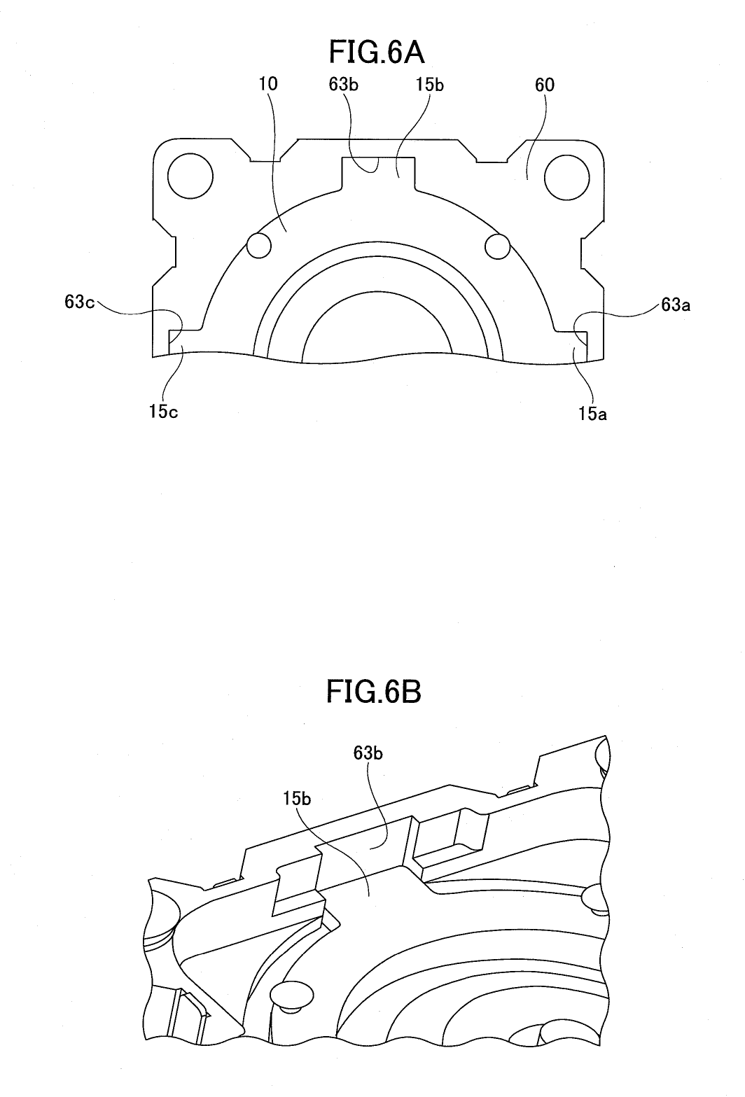

As illustrated in FIGS. 6A and 6B, the direction key 10 has convex-shaped rotation stoppers 15a-15d protruding from on an outer side surface of an outer rim part 18 of the direction key 10. The rotation stoppers 15a-15d prevent the direction key 10 from rotating by engaging with concave-shaped rotation stoppers 63a-63d formed at a peripheral part of an opening 61 of the case 60. Alternatively, the rotation stoppers 15a-15d may be formed in a concave shape whereas the rotation stoppers 63a-63d may be formed in a convex shape. The concave part of the rotation stoppers 15a-15d and the convex part of the rotation stoppers 63a-63d are formed in a direction parallel to the operation surface 13 of the direction key 10. Thereby, the direction key 10 is prevented from rotating within a plane that is parallel to the operation surface 13.

By forming both the direction key 10 and the case 60 with a resin material, this can reduce friction and wear created at a contact surface between the rotation stoppers 15a-15d and the rotation stoppers 63a-63d. Accordingly, when the direction key 10 is inclined in a state where a contact point between the flange 12 and the upper inner surface 62 of the case 60 acts as a fulcrum of the inclination or when the direction key 10 is slid at the contact point, friction and wear created by the inclining and sliding movement can be reduced. The resin material also reduces friction resistance and enhances an operating feel of the operator (user) of the electronic device on which the operation input key 1 is mounted. The return spring 40 resiliently deforms by operating the direction key 10. However, because the return spring 40 is received by the recess part 19 formed in the lower surface 14 of the direction key 10, wear and friction generated between a receiving surface of the recess part 19 and the return spring 40 can be reduced.

A cover 65 is formed on an upper surface of the case 60. The cover 65 includes an opening 66 allowing the direction key 10 to penetrate therethrough. By forming the cover 65 with a metal material, the cover 65 serves as a shield that protects internal components from static electricity.

The operation input device 1 includes a center key (depression key) 20. The center key 20 is supported by being provided between the direction key 10 and the click spring 70. The center key 20 has a surface that is exposed at the operation surface 13 of the operation key 10 in the X direction. A flange 21 is formed at a peripheral part of the center key 20. The position of the flange 21 is set by engaging the flange 21 with an opening 11 formed at a center part of the direction key 10. In a case where the center key 20 is depressed, the depression of the center key 20 causes a peak part of the click spring 70 provided above the substrate 50 to deform downward.

A lower yoke 80 is provided below the substrate 50. By providing the lower yoke 80, it becomes easier to detect changes of inductance. The case 60 is attached to four corners of the lower yoke 80 in a state having the substrate 50 interposed between the lower yoke 80 and the case 60.

Next, a configuration for detecting the amount of displacement of the direction key 10 of the operation input device 1 according to an embodiment of the present invention is described in detail.

The substrate 50 included in the operation input device 1 has an arrangement surface on which plural coils (in this embodiment, the four coils 71a, 72a, 73a, 74a) are arranged. The arrangement surface of the substrate 50 is parallel to an XY plane. The substrate 50 may be a resin substrate such as a flexible substrate or a FR-4 substrate. If an insulating property can be attained, the substrate 50 may be, for example, a steel plate or an iron plate formed from a silicon steel material.

The four coils 71a, 72a, 73a, and 74a are arranged along a circumference of an imaginary circle formed by connecting points having the same distance relative to an origin point (reference point) O of a three-dimensional orthogonal coordinate system. It is preferred that the coils 71a, 72a, 73a, and 74a are equally spaced apart from each other along the periphery of the circle, so that the vector of force exerted by the operation can be easy to calculate. In a case where all of the coils 71a, 72a, 73a, and 74a have the same characteristics, the distance of the center of gravity of a pair of adjacent coils is the same as the distance of the center of gravity of another pair of adjacent coils. The coils 71a, 72a, 73a, and 74a are arranged in four directions oriented 45 degrees in an XY plane between the X axis and the Y axis. Adjacent ones of the coils 71a, 72a, 73a, and 74a are arranged 90 degrees along a peripheral direction. For example, the coil 74a is arranged at a first quadrant angle, the coil 71a is arranged at a second quadrant angle, the coil 72a is arranged at a third quadrant angle, and the coil 73a is arranged at a fourth quadrant angle.

The coils 71a, 72a, 73a, and 74a may be arranged 90 degrees on the X and Y axes in four directions, that is, the X (+) direction, the X (−) direction, the Y (+) direction, and the Y (−) direction. The X (−) direction is oriented in an opposite direction (180 degrees) with respect to the X (+) direction on the XY plane. The Y (−) direction is oriented in an opposite direction (180 degrees) with respect to the Y (+) direction on the XY plane.

As described above, the direction key 10 is an operation key that is displaced by receiving an exerted input operation force. The amount in which the direction key 10 is displaced from the opening 61 of the case 60 to the inside of the case 60 progressively (successively) changes in correspondence with the amount of input operation force exerted on the direction key 10.

The operation input device 1 has a detection unit that detects the position of the direction key 10 without contacting the direction key 10 and outputs a signal in correspondence with the amount of displacement of the direction key 10. In this embodiment, the coils 71a, 72a, 73a, and 74a and the below-described detection part 160 constitute the detection unit. In the detection unit, the inductance of each of the coils 71a, 72a, 73a, and 74a changes according to the amount of displacement of the direction key 10 and the direction of the displacement of the direction key 10.

The coils 71a, 72a, 73a, and 74a detect the position of the direction key 10 without contacting the direction key 10. That is, the coils 71a, 72a, 73a, and 74a detect the position of the direction key 10 with the upper yoke 75 fixed to the lower surface 14 of the direction key 10. The coils 71a, 72a, 73a, and 74a output signals having waveforms corresponding to the detected amounts of displacement of the direction key 10. Thus, the coils 71a, 72a, 73a, and 74a are also referred to as detection members. The coils 71a, 72a, 73a, and 74a may be winding wires (conducting wire) that are wound into a circular cylinder shape. Although it is preferable for the coils 71a, 72a, 73a, and 74a to be wound in a circular cylinder shape, the coils 71a, 72a, 73a, and 74a may be wound into other shapes as long as the shape is a cylinder. For example, the coils 71a, 72a, 73a, and 74a may be wound into a rectangular cylinder shape. Further, the coils 71a, 72a, 73a, and 74a may be wound around a bobbin for facilitating attachment and improving shock resistance.

The upper yoke 75 is displaced in cooperation with the displacement of the direction key 10. The upper yoke 75 may be provided on the lower surface of the flange 12 in the same number as the number of coils 71a, 72a, 73a, and 74a arranged on the substrate 50. The direction key 10 is toward the side from which input operation force is exerted on the coils 71a, 72a, 73a, and 74a. The direction key 10 may be formed from a planar member. As described above, the direction key 10 includes the lower surface 14 facing upper end surfaces of the coils 71a, 72a, 73a, and 74a and the operation surface 13 on which input operation force is directly or indirectly exerted from the operator. The material of the upper yoke 75 is not to be limited as long as the material has a relative magnetic permeability that is higher than 1. It is preferable for the material of the upper yoke 75 to have a relative magnetic permeability equal to or higher than 1.001. For example, it is preferable to use a steel plate having a relative magnetic permeability of 5000.

The upper yoke 75 is a component separate from the direction key 10. The upper yoke 75 and the coils 71a, 72a, 73a, 74a are positioned facing each other. The input operation force exerted by the operator on the operation surface 13 changes the position of the upper yoke 75 located above the upper end surfaces of the coils 71a, 72a, 73a, 74a. The change of position of the upper yoke 75 changes the inductance of the coils 71a, 72a, 73a, and 74a.

The upper yoke 75 may include cores formed in correspondence with the coils 71a, 72a, 73a, and 74a. For example, the inductance of each of the coils 71a, 72a, 73a, 74a may be changed by displacing the inside (hollow part) the corresponding core of the upper yoke 75 in the direction of an axis line of a corresponding coil 71a, 72a, 73a, 74a. In a case where the coils 71a, 72a, 73a, and 74a are wound in a circular cylinder shape, it is preferable for the core to be a magnetic member having a circular cylinder shape. In a case where the coils 71a, 72a, 73a, and 74a are wound in a rectangular cylinder shape, it is preferable for the core to be a magnetic member having a rectangular cylinder shape.

By detecting the inductance of each of the coils 71a, 72a, 73a, and 74a, the direction of the input operation force relative to the origin point of the orthogonal coordinate system (i.e. input position of the input operation force on the XY plane) and the size of the input operation force (amount of force exerted in the X direction) can be calculated.

The return spring 40 serves as a support member that supports the direction key 10 in a manner that the direction key 10 can be displaced downward. In addition, the return spring 40 also serves as a resilient support member that resiliently supports the direction key 10 in a manner that the space between the upper yoke 75 provided on the lower surface 14 of the direction key 10 and the coils 71a, 72a, 73a, 74a changes in correspondence with the resilient movement of the return spring 40.

The return spring 40 is positioned between the substrate 50 and the lower surface 14 of the direction key 10. Accordingly, even in a case where the operator exerts force on the direction key 10, the return spring 40 resiliently supports the direction key 10, so that the upper yoke 75 and the coils 71a, 72a, 73a, 74a of the substrate 50 do not contact each other. Further, the return spring 40 supports the direction key 10 in a manner that the direction key 10 can be inclined with respect to the XY plane that is orthogonal to the Z axis. Further, the return spring 40 supports the direction key 10 in a state where the lower surface 14 of the direction key 10 is urged in a direction separating from the coils 71a, 72a, 73a, 74a of the substrate 50.

Further, the return spring 40 resiliently supports the direction key 10 in a manner that the operation surface 13 of the direction key 10 is parallel to the XY plane in a state where no force is exerted by the operator on the direction key 10. The operation surface 13 of the direction key 10 may be flat. Alternatively, the operation surface 13 of the direction key 10 may be recessed relative to the XY plane. Alternatively, the operation surface 13 of the direction key 10 may protrude relative to the XY plane. By forming the operation surface 13 into a desired shape, the operability can be enhanced for the operator. Further, the shape of the operation surface 13 of the direction key may be, for example, a circular shape, an elliptical shape, or a polygonal shape.

Further, the return spring 40 is a coil spring that exerts a spring force in a direction from the inside of the case 60 toward the opening 61 of the case 60. In a case of using a circular conic shaped coil spring as the return spring 40, the durability of the return spring 40 can be improved. Further, by using a circular conic shaped coil spring as the return spring 40, it becomes easier for the direction key 10 to be inclined relative to the opening 61. The return spring 40 constantly exerts an upward force to the direction key 10 such that the upward force causes the direction key 10 to return to its initial height position (i.e., the position of the direction key 10 illustrated in FIGS. 5A, 5B) when the direction key 10 is depressed by the operator. Although the return spring 40 in this embodiment is a circular conic shaped coil spring, the return spring 40 may be replaced with an endless elastic member such as rubber.

As illustrated in FIGS. 5A and 5B, the operation input device 1 has the direction key 10 attached to the case 60 in a state where the direction key 10 is urged into contact with the inner side of the case 60. That is, the direction key 10 contacts an upper inner surface 62 of the case 60 and is supported in such state by the reactive force of the return spring 40.

As described above, the case 60 is a housing of an electronic device (e.g., mobile phone) on which the operation input device 1 is mounted. The operation input device 1 itself may include the case 60. Although the opening 61 of the upper surface of the case 60 has a circular shape according to this embodiment, the opening 61 can be formed in a shape matching the shape of the direction key 10. For example, the shape of the opening 61 may be a polygonal shape such as a quadrangle or an octagon.

The case 60 defines the maximum height (Z direction) in which the direction key 10 can be moved by the upward force exerted by the return spring 40. The maximum stroke force of the direction key 10 is set to an amount so that the position of the direction key 10 can be detected without contacting the coils 71a, 72a, 73a, 74a. That is, a space equivalent to the maximum amount of stroke force can be accommodated inside the case 60.

The detection part 160 electrically detects the successive changes of the upper yoke (analog displacement amount) by electrically detecting changes of inductance of the coils 71a, 72a, 73a, and 74a. Then, the detection part 160 outputs detection signals in correspondence with the detected analog amount of displacement (i.e. amount of displacement of the direction key 10 (amount of input operation force)). The substrate 50 of the operation input device 1 may constitute the detection part 160. Alternatively, a detection circuit mounted on a substrate (not illustrated) such as a substrate of an electronic device on which the operation input device 1 is mounted may constitute the detection part 160.

Next, an example where the detection part 160 detects changes of inductance (in this example, changes of inductance evaluation value) of the coil 71a is described. Because the same applies to changes of inductance of each of the coils 72a, 73a, and 74a, detection of changes of inductance of each of the coils 72a, 73a, and 74a is not described.

In this example, the detection part 160 detects a physical quantity of a target object that equivalently changes with the changes of the inductance of the coil 71a. The detection part 160 outputs the value of the detected physical quantity as a value equivalent to the amount of displacement of the upper yoke 75 relative to the coil 71a. Alternatively, the detection part 160 may calculate the inductance of the coil 71a by detecting the physical quantity that equivalently changes with the changes of the inductance of the coil 71a and output the value of the calculated inductance as the value equivalent to the amount of displacement of the upper yoke 75 relative to the coil 71a. Further, alternatively, the detection part 160 may calculate the amount of displacement of the upper yoke 75 relative to the coil 71 based on the value of the detected physical quantity or the value of the calculated inductance and output the value of the calculated amount of displacement.

More specifically, the detection part 160 causes the coil 71a to generate a signal having a waveform that changes in correspondence with the size of the inductance of the coil 71a by supplying a pulse signal to the coil 71a and electrically detects changes of inductance of the coil 71a based on the waveform of the generated signal.

For example, the magnetic permeability at the periphery of the coil 71a increases as the amount of downward displacement of the upper yoke 75 above the upper end surface of the coil 71a or inside the hollow part increases. As a result, the amplitude of a pulse voltage waveform generated on both ends of the coil 71a increases. The pulse voltage waveform is generated by supplying a pulse signal to the coil 71a. Accordingly, the amplitude of the pulse voltage waveform is assumed as the physical quantity that equivalently changes in correspondence with the changes of the inductance of the coil 71a. Thus, assuming that the amplitude of the pulse voltage waveform is the physical quantity, the detection part 160 detects the amplitude of the pulse voltage waveform and outputs the value of the detected amplitude as a value equivalent to the amount of displacement of the upper yoke 75 relative to the coil 71a. Further, the detection part 160 may calculate the inductance of the coil 71a from the value of the detected amplitude and output the value of the calculated inductance as a value equivalent to the amount of displacement of the upper yoke 75 relative to the coil 71a.

Further, as the inductance of the coil 71a increases, the inclination (gradient) of the pulse voltage waveform generated by the supply of pulse signals becomes more gradual. Accordingly, the inclination of the pulse voltage waveform may be assumed as the physical quantity of a target object that equivalently changes in correspondence with the changes of the inductance of the coil 71a. Thus, assuming that the inclination of the pulse voltage waveform is the physical quantity, the detection part 160 detects the inclination of the pulse voltage waveform and outputs the value of the detected inclination as a value equivalent to the amount of displacement of the upper yoke 75 relative to the coil 71a. Further, the detection part 160 may calculate the inductance of the coil 71a from the value of the detected inclination and output the value of the calculated inductance as a value equivalent to the amount of displacement of the upper yoke 75 relative to the coil 71a.

FIG. 5C is a cross-sectional view of the operation input device 1 according to an embodiment of the present invention in a state where the direction key 10 is inclined by an input operation force being exerted in a direction between the coil 73a and the coil 74a. In a case where the direction key 10 is pressed downward in the X direction against the upward spring force of the return spring 40, the direction key 10 is inclined where the contact point between the flange 12 and the upper inner surface 62 of the case 60 acts as a fulcrum of the inclination. Thereby, the upper yoke 75 approaches toward the coil 73a and the coil 74a. In a case where the upper yoke 75 has cores protruding downward therefrom, the cores advance into the hollow parts of the coils 73a, 74a. By the approach of the upper yoke 75 toward the coils 73a, 74a (advance of the cores of the upper yoke 75 into the hollow parts of the coils 73a, 74a), the magnetic permeability surrounding the coils 73a, 74a and the self-inductance of the coils 73a, 74a increase. The increase of the magnetic permeability and self-inductance also occurs in a case where the direction key 10 is inclined downward in other directions. Accordingly, based on the size of the inductance evaluation values detected from each of the coils 71a-74a or from the detection part 160, the direction of the inclination of the direction key 10 and the quantity of the stroke force of the direction key 10 can be detected.

Further, the present invention is not limited to these embodiments, but variations and modifications may be made without departing from the scope of the present invention.

For example, the support member for resiliently supporting the direction key 10 is not limited to an elastic member as the return spring 40. For example, a rubber member, a sponge member, or a cylindrical member filled with gas or oil may be used as the support member.

The operation input device 1 is not limited to being operated with a finger of a hand. For example, the operation input device 1 may be operated with a palm of a hand, a toe of a foot, or a back of a foot. The operation surface 13 is not limited to a flat surface. For example, the operation surface 13 may be a concave surface or a convex surface.

The present application is based on Japanese Priority Application No. 2011-088351 filed on Apr. 12, 2011, with the Japanese Patent Office, the entire contents of which are hereby incorporated by reference.

What is claimed is:

1. An operation input device comprising:
an operation member that includes an operation surface having an outer edge part and is configured to be displaced downward by an input operation force exerted on the operation surface;
a yoke attached to the operation member;
a coil that detects a position of the operation member based on a position of the yoke and outputs a signal corresponding to an amount in which the operation member is displaced downward; and
an engagement part that is positioned below the operation member and configured to contact the operation member at a contact position immediately below the outer edge part of the operation member;
wherein the engagement part is configured to constrain the operation member so that the operation member is not displaced further downward than the contact position when the engagement part contacts the operation member.

2. The operation input device as claimed in claim 1, wherein the operation member has a lower surface on which a protrusion is provided in a manner protruding from a lower surface of the yoke.

3. The operation input device as claimed in claim 1, further comprising an elastic member;
wherein the operation member includes a flange;
wherein the elastic member is configured to exert an upward force on the operation member so that the flange contacts an upper member positioned above the flange.

4. The operation input device as claimed in claim 3, further comprising:
a click spring;
wherein the operation member includes a depression part provided at a center area thereof;
wherein the click spring is configured to deform when the depression part is depressed;
wherein the engagement part includes at least one of an elastic support member configured to support the elastic member and a click spring support member configured to support the click spring.

5. The operation input device as claimed in claim 3,
wherein the operation member and the upper member includes a rotation stopping member;
wherein each of the rotation stopping member of the operation member and the rotation stopping member of the upper member are configured to constrain rotation of the operation member by engaging each other.
